(19) United States
(12) Patent Application Publication
(10) Pub. No.: US 2020/0093333 A1
(43) Pub. Date: Mar. 26, 2020

(54) TOOL FOR HOLDING AND ROASTING MARSHMALLOWS

(71) Applicant: Jeff A. Roste, Alexandria, MN (US)

(72) Inventor: Jeff A. Roste, Alexandria, MN (US)

(21) Appl. No.: 16/577,111

(22) Filed: Sep. 20, 2019

Related U.S. Application Data
(60) Provisional application No. 62/734,682, filed on Sep. 21, 2018.

(51) Int. Cl. A47J 43/28

(52) U.S. Cl. CPC A47J 43/283

(57) ABSTRACT

A tool for roasting marshmallow includes a handle and a marshmallow receiver or basket at a roasting end of the handle for use in holding a marshmallow over a heat source. The basket opens back towards a grip end of the handle. The distal end of the basket is closed so that a marshmallow cannot slide out of the basket when a roasting end of the handle is held below horizontal. The roasting end of the handle is bent to include an offset handle segment which is offset relative to a longitudinal axis through the grip end of the handle with the offset handle segment extending along one side of the basket. An axis extending through the center of the basket is axially aligned with a longitudinal axis of the grip end of the handle so that the basket may be rotated coaxially with the grip end of the handle.

### CROSS-REFERENCE TO RELATED APPLICATIONS

This application claims the benefit of U.S. Provisional Patent Application No. 62/734,682, filed Sep. 21, 2018 the disclosure of which is hereby incorporated herein in its entirety by reference.

### BACKGROUND OF THE INVENTION

### Field of the Invention

This invention relates to tools to facilitate the roasting of marshmallows.

### Description of the Related Art

Commonly used tools for roasting marshmallows over an open fire include pointed sticks or forks with relatively long handles. Anyone who has roasted marshmallows is familiar with the difficulty in rotating a marshmallow on a pointed stick in an effort to roast the marshmallow uniformly around its periphery. Once the inside of the marshmallow softens, the marshmallow sags downward on the stick and the stick will rotate freely within the marshmallow or the outer portion of the marshmallow will rotate relative to the inner portion pierced by the stick. The softened portion of the marshmallow is then prone to slide off the end of the stick if the user inadvertently drops the distal end of the stick below horizontal. To keep the roasting stick horizontal or angled slightly upward the user typically needs to bend down or squat low relative to the fire which makes the process of roasting the marshmallow uncomfortable.

Forks having tines spaced to pierce the marshmallow in two places address the issue of rotating the marshmallow but will still allow a marshmallow to slide off the end if the user is not careful. There remains a need for an improved tool for roasting marshmallows that allows uniform roasting of a marshmallow and which will prevent the marshmallow form falling off the tool into the fire.

### SUMMARY OF THE INVENTION

The present invention comprises a tool with an elongate handle and a marshmallow receiver for use in holding a marshmallow over a heat source such as a campfire to facilitate roasting of the marshmallow. The handle includes a grip end and a roasting end with the marshmallow receiver secured to the roasting end of the handle. The marshmallow receiver may also be described as a basket, cage or mitt which opens back towards the grip end of the handle. The distal end of the marshmallow receiver is closed or includes an obstruction so that a marshmallow cannot slide out of the marshmallow receiver when the roasting end of the marshmallow holder drops or is held below horizontal. In a preferred embodiment, the roasting end of the handle is bent to include an offset handle segment which extends in offset relationship relative to a longitudinal axis through the grip end of the handle with the offset handle segment extending along one side of the marshmallow receiver and an axis extending through the center of the marshmallow receiver is axially aligned with a longitudinal axis of the grip end of the handle. With the axis of the receiver and the grip end of the handle aligned, the marshmallow receiver rotates coaxially with the grip end of the handle.

The marshmallow receiver is preferably formed by a plurality of fingers or tines projecting transverse to a base which is connected to and extends laterally relative to the roasting end of the handle. In a preferred embodiment, the base of the marshmallow receiver includes a central hub with five spokes projecting radially outward from the hub. The spokes preferably extend in equal angular spacing or 72 degrees apart for 5 spokes. The spokes are of equal length and one of the spokes is connected at an end opposite the hub to a distal end of the handle at the roasting end thereof. The roasting end of the handle functions as or replaces one of the fingers. Additional fingers are each connected to the end of a respective one of the other spokes and extend transverse to the spoke back toward the grip end of the handle.

The volume or space circumscribed by inner surfaces of the plurality of fingers is slightly larger than the volume occupied by an unroasted marshmallow of a conventional size for roasting but smaller than the expanded volume of the marshmallow when roasted. Because the marshmallow receiver opens inward toward the grip end of the handle, the marshmallow will not fall out of the marshmallow receiver when the user drops the roasting end of the marshmallow holder below horizontal. Expansion of the marshmallow into or against the fingers further helps hold the marshmallow in the holder if the marshmallow receiver is raised upward with the opening of the receiver opening downward. The gaps between the fingers allow even roasting of a majority of the peripheral surface of the marshmallow and allow the user to grasp the roasted marshmallow with his or her fingers to remove the marshmallow from the receiver.

### BRIEF DESCRIPTION OF THE DRAWINGS

FIG. 1 is a perspective view of a marshmallow roasting tool of the present invention.

FIG. 2 is an enlarged and fragmentary perspective view of a roasting end of the marshmallow roasting tool.

FIG. 3 is a fragmentary side view of the marshmallow roasting tool.

FIG. 4 is an end view of the marshmallow roasting tool looking from a roasting end toward a grip end with an unroasted and roasted marshmallow represented by dashed lines.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

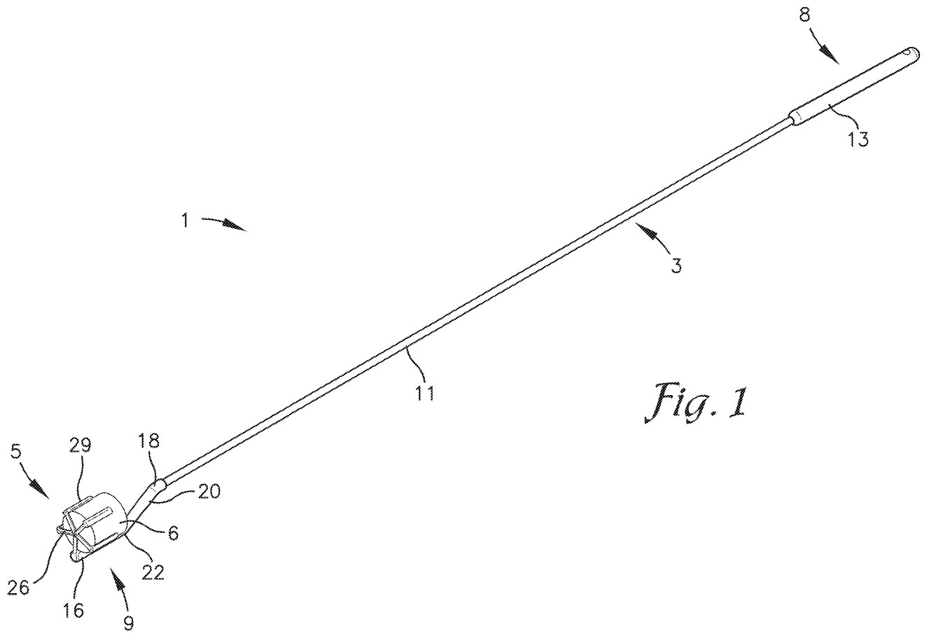

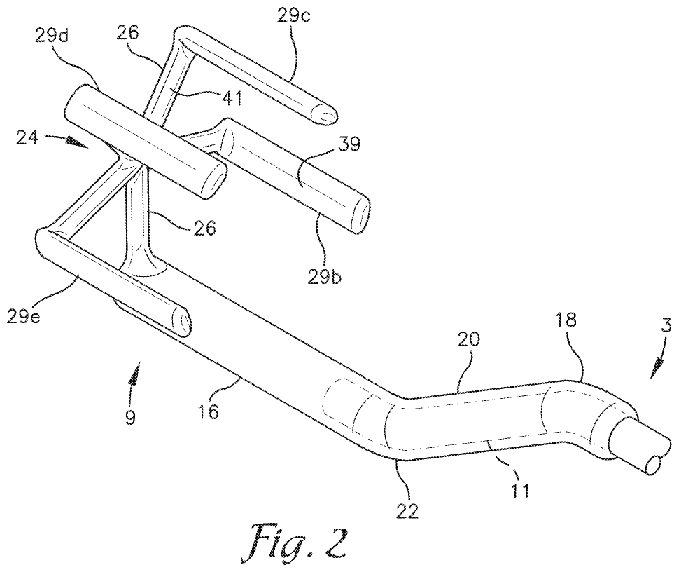

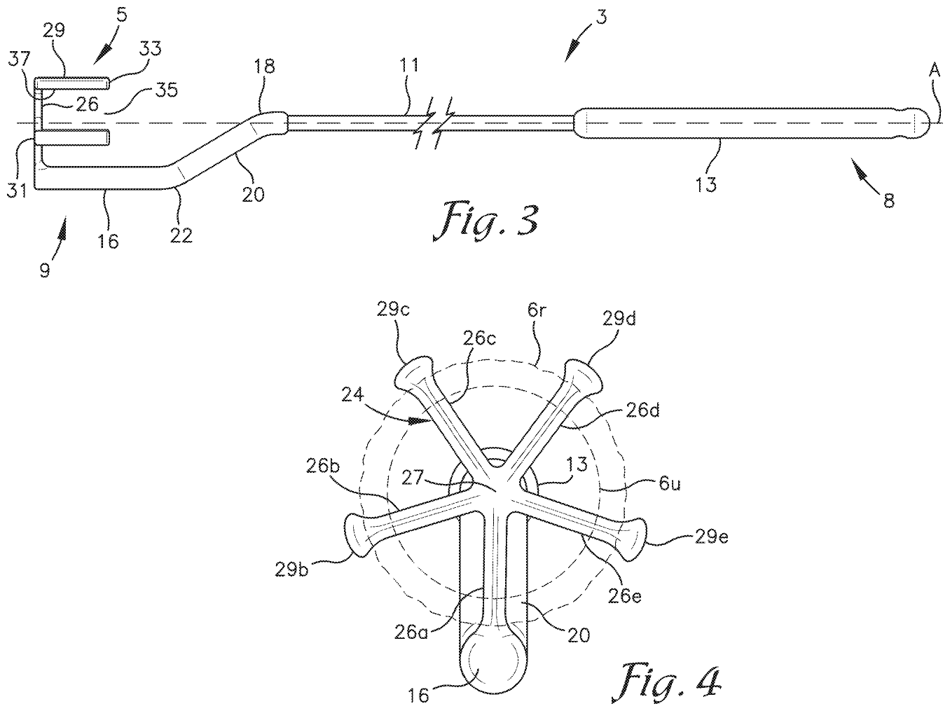

A marshmallow roasting tool or marshmallow holder 1 in accordance with the present invention is shown in FIGS. 1-4. The marshmallow roasting tool includes an elongate handle 3 and a marshmallow receiver 5 for use in holding a marshmallow 6 over a heat source such as a campfire to facilitate roasting of the marshmallow. The handle 3 includes a grip end 8 and a roasting end 9 with the marshmallow receiver 5 secured to the roasting end 9 of the handle 3. The marshmallow receiver may also be described as a basket, cage or mitt which opens back towards the grip end 8 of the handle 3.

In the embodiment shown, the handle 3 is formed from a rigid rod 11 with a softer grip 13 secured to the rod 11 at the grip end 8 of the handle 3 and the marshmallow receiver secured to the rod 11 at a roasting end 9 of the handle 3. The rod 11 may be formed from aluminum, fiberglass or other rigid materials including metals other than aluminum that will not melt or soften to the point of losing their rigidity when held in close proximity to or over a heat source such as a campfire. The handle 3 may also be formed from a telescoping or folding assembly to allow compact storage. The grip 13 may be formed from a flexible polymeric material, including for example, a silicone material that is molded onto and over the rod 11. In a preferred embodiment, as shown in FIGS. 1-4, the marshmallow receiver 5 is formed form a polymeric, food safe silicone molded onto the end of the rod 11 at the roasting end 9 of handle 3. The grip 13 may be formed from the same food safe silicone as the receiver 5.

In the embodiment shown, the roasting end 9 of the handle 3 is bent to include an offset handle segment 16 which extends in offset relationship relative to a longitudinal axis A through the grip end 8 of the handle 3 with the offset handle segment 16 extending along one side of the marshmallow receiver 5. The marshmallow receiver 5 is sized and positioned relative to the offset handle segment 16 such that an axis extending through the center of the marshmallow receiver 5 is axially aligned with the longitudinal axis A through the grip end 8 of the handle 3 so that the marshmallow receiver 5 and the grip end 8 of the handle 3 are rotatable about the same axis A. Moving from the grip end 8 to the roasting end 9 of handle 3, the handle 3 includes a first bend 18 forming an angled segment or neck 20 which angles away from the longitudinal axis A through the grip end 8 of handle 3 at an acute angle which in one embodiment is approximately twenty-five degrees. It is foreseen that the angled segment 20 could angle away from axis A at a variety of angles but preferable the angle is in the range from approximately fifteen to forty-five degrees. A second bend 22 of a complimentary angle as first bend 18 is formed in the handle 3 between the angled segment 20 and the offset handle segment 16. The offset handle segment 16 thereby extends parallel to the longitudinal axis A through the grip end 8 of handle 3 in laterally spaced relationship thereto. The offset handle segment 16 may be formed from polymeric, food safe silicone molded over the distal end of the rod 11. The portion of the offset handle segment 16 formed from silicone is formed integral with the marshmallow receiver 5.

The marshmallow receiver 5 includes a base 24 formed from a plurality of spokes 26 radiating outward from a central hub 27. The embodiment shown includes five spokes 26a-e projecting radially outward from the hub 27 in an equal angular spacing of seventy-two degrees. The spokes 26 are of equal length and one of the spokes, first spoke 26a, is connected, at an end opposite the hub 27, to a distal end of the offset handle segment 16. The first spoke 26a preferably extends transverse to the offset handle segment 16. A finger 29, comprising one of four fingers 29b-e, is connected to and extends transverse to a distal end of each of the spokes 26b-e respectively, and back toward the grip end 8 of the handle 3. In the embodiment shown, the fingers 29b-e are of equal lengths but shorter than the length of the offset handle segment 16. In the embodiment shown, the fingers 29b-e and the distal end of the offset handle segment 16 are shown extending in parallel alignment with the axis A through the grip end 8 of the handle 3.

The base 24, or distal or closed end of the receiver 5, and the fingers 29b-e in combination with the offset handle segment 16 form the marshmallow receiver 5. The fingers 29b-e and the offset handle segment 16 enclose or circumscribe a volume or space sized slightly larger than the diameter of an unroasted marshmallow 6 supported on base 24. The spokes 26 and hub 27 form an obstruction to prevent the marshmallow from passing through the distal end 31 of the marshmallow receiver 5. The area between inner ends 33 of the fingers 29 is unobstructed to form a receiver opening 35 through which a marshmallow 6 may be positioned in the marshmallow receiver 5. The receiver opening 35 opens toward the grip end 8 of the handle 3. Gaps 37 are formed between adjacent fingers 29b-e and between offset handle segment 16 and fingers 29b and 29e respectively.

As best seen in FIG. 4, the volume or space circumscribed by inner surfaces of each of the fingers 29b-e and offset handle segment 16 is preferably slightly larger than the volume occupied by an unroasted marshmallow 6 of a conventional size for roasting but smaller than the expanded volume of the marshmallow 6 when roasted. Referring to FIG. 4, the volume occupied by an unroasted marshmallow is represented by dashed line 6u and the volume occupied by a roasted marshmallow is represented by dashed line 6r. Because the marshmallow receiver 5 opens inward toward the grip end 8 of the handle 3, the marshmallow 6 will not fall out of the marshmallow receiver 5 when the user drops the roasting end 9 of the tool 1 below horizontal. Expansion of the marshmallow 6 into or against the fingers 29b-e and offset handle segment 16 further helps hold the marshmallow 6 in the receiver 5 if the marshmallow receiver 5 is raised upward so that it opens downward. The gaps 37 between the fingers 29b-e and offset handle segment 16 allow even roasting of a majority of the peripheral surface of the marshmallow 6 received therein and allow the user to grasp the roasted marshmallow 6 with his or her fingers to remove the marshmallow 6 from the marshmallow receiver 5.

In the embodiment shown, the fingers 29 are ovate in cross-section presenting a convex inner surface 39. The offset handle segment 16 similarly presents a convex inner surface 39. When a marshmallow 6 in the receiver 5 expands upon heating, the outer surface of the marshmallow first contacts the inwardly facing convex touch points 39 of each of the fingers 29 and of the offset handle segment 16. The rest of the marshmallow then expands around the fingers 29 and offset handle segment 16 and into the gaps 37. The spokes 26 include radiused contact points 41 which help minimize the contact between the bottom of the marshmallow 6 and the spokes 26 to facilitate removal of a roasted marshmallow 6 and greater exposure of the bottom surface of the marshmallow 6 for roasting.

The size and positioning of the marshmallow receiver 5 such that an axis through the center of the receiver 5 is aligned with the longitudinal axis through the grip end 8 of the handle 3 results in rotation of the receiver 5 and a marshmallow 6 positioned therein about the same axis A as the grip handle 3 making it easier for a user to control the rotation of the marshmallow over a heat source to obtain more even and uniform roasting of the marshmallow 6. The orientation of the receiver opening 35 to open toward the grip end 8 of the handle 3 also prevents the marshmallow from falling out of the receiver 5 and off the tool 1 when the roasting end 9 of the tool 1 is extended below horizontal.

It is foreseen that the receiver 5 could be formed so that the offset handle segment 16 did not form a part of the receiver 5. For example, an additional finger 29, instead of a spoke 26, could be connected to the offset handle segment 16. Or the offset handle segment 16 could end in alignment with the inner ends 33 of fingers 26b-d and an additional finger 26a (not shown) could then extend past the end of offset handle segment 26.

It is to be understood that while certain forms of the present invention have been illustrated and described herein, it is not to be limited to the specific forms or arrangement of parts described and shown.

What is claimed is:

1. A tool for holding and roasting a marshmallow comprising:
a handle having a grip end and a roasting end;
a marshmallow receiver secured to the roasting end of the handle, the marshmallow receiver having an obstructed end and an open end opposite the obstructed end and opening toward the grip end of the handle, the marshmallow receiver sized to receive a marshmallow therein through the open end.

2. The tool as in claim 1 wherein a longitudinal axis through the marshmallow receiver is aligned with a longitudinal axis through the grip end of the handle such that the marshmallow receiver and the grip end of the handle are rotatable about a common axis of rotation.

3. The tool as in claim 2 wherein the roasting end of the handle is offset from the longitudinal axis through the grip end of the handle; the marshmallow receiver is formed by a plurality of spokes projecting radially outward from a hub and a plurality fingers, each finger connected to and extending from a respective spoke toward the grip end of the handle, except for a first spoke which is connected to the roasting end of the handle, the fingers spaced apart to allow the marshmallow to be physically inserted or removed from the marshmallow receiver without a user touching any part of the marshmallow receiver or the plurality of fingers.

4. The tool as in claim 3 wherein the fingers extend in parallel alignment with the axis through the grip end of the handle.

5. A tool for marshmallows comprising:
a handle having a grip end and a roasting end with an offset handle segment formed in the roasting end of the handle with said offset handle segment extending in offset relation to a longitudinal axis of the grip end of the handle;
a marshmallow receiver secured to the offset handle segment of the roasting end of the handle, the marshmallow receiver comprising a base with a plurality of fingers extending from the base in spaced relationship and toward the grip end of the handle, the fingers enclosing a space into which a marshmallow may be received through an opening into the marshmallow receiver formed at inner ends of the fingers opposite the base and opening toward the grip end of the handle.

6. The tool as in claim 5 wherein an axis through said marshmallow receiver is aligned with an axis through said grip end of the handle such that the marshmallow receiver and the grip end of the handle are rotatable about a common axis of rotation.

7. The tool as in claim 5 wherein the fingers extend in parallel alignment with an axis through the grip end of the handle.

8. The tool as in claim 5 wherein the base is formed from a plurality of spokes extending radially outward from a hub with a first spoke connected to the offset handle segment and each of the fingers is connected to a respective one of the remaining spokes.

9. The tool as in claim 8 wherein an axis through the hub of the base of the marshmallow receiver is aligned with an axis through said grip end of the handle such that the marshmallow receiver and the grip end of the handle are rotatable about a common axis of rotation.
